(19) United States
(12) Patent Application Publication
(10) Pub. No.: US 2013/0030718 A1
(43) Pub. Date: Jan. 31, 2013

(54) APPARATUS AND METHOD FOR AIR MONITORING

(71) Applicants: Andrew Williams, High Wycombe (GB); Mahahettige Don Anton Earle Stephen Perera, Berkhamsted (GB); Stuart Leslie Upton, Luton (GB)

(72) Inventors: Andrew Williams, High Wycombe (GB); Mahahettige Don Anton Earle Stephen Perera, Berkhamsted (GB); Stuart Leslie Upton, Luton (GB)

(21) Appl. No.: 13/553,635

(22) Filed: Jul. 19, 2012

(30) Foreign Application Priority Data
Jul. 25, 2011 (GB) 1112736.2

(51) Int. Cl. G06F 19/00

(52) U.S. Cl. 702/24

(57) ABSTRACT

An apparatus for monitoring air for target air contaminants particularly on board an aircraft, comprises: means for sensing ultrafine particles in air; a database; and a processor for receiving information output from the sensing means; wherein the processor is adapted to monitor the information output from the sensing means and to compare this information with data in the database to identify target air contaminants such as volatile and/or semi-volatile organic compounds.

The present invention relates to an apparatus and method for monitoring air for target air contaminants. In particular, it relates to an apparatus and method for air monitoring in a cabin and/or flight deck of an aircraft.

When airborne, air for the cabin of an aircraft is drawn from the engine compressors of the aircraft. Occasionally, an incident occurs whereby there is a leakage of oil or hydraulic fluid. For example, a seal may leak and engine oil escapes. As a consequence of the high temperature and high pressure in the engine environment, escaped engine oil or its decomposition products may be introduced to the aircraft cabin. These processes can produce, amongst others, airborne semi-volatile organic compounds (SVOCs) and volatile organic compound (VOCs). The semi-volatile organic compounds can include organophosphates, being one example of a target air contaminant.

U.S. Pat. No. 7,824,479 discloses an apparatus for sampling air in an aircraft cabin. This apparatus comprises at least one adsorbent tube; means for isolating the adsorbent tube from contamination; means for drawing air through the adsorbent tube; means for sensing air contamination; a processor for receiving information from the sensing means and determining when contamination has occurred; and means for detecting when the apparatus is airborne.

When contaminated air is detected, the air is drawn through the adsorbent sampling tube which absorbs the semi-volatile and volatile organic compounds arising from the incident. Preferably, several adsorbent tubes are present which are used sequentially as incidents arise. However, for issues of space, only a limited number of adsorbent tubes can be arranged in the apparatus for sampling. Once these adsorbent tubes have all been exposed to contaminated air, it is no longer possible to sample the air during the remainder of the flight. When the aircraft in question has returned to base, the sampling apparatus is removed from the aircraft so that the adsorbent tubes can be taken away for analysis of their contents, to confirm the nature of the air contamination.

Using this apparatus, the present inventors have identified the following volatile organic compounds in the cabin of aircraft during flights: benzene, toluene, ethyl benzene, undecane, various siloxanes and components of hydraulic fluids. They have also identified the semi-volatile organic compounds tricresylphosphates, together with other components of engine oils. One or more of these compounds may be the target air contaminants of the present invention.

Other possible target air contaminants of the present invention, expressed in more general terms, are the engine oil itself or its decomposition products considered en masse.

WO 2008/118624 A2 discloses a method for detection of an airborne air contaminant. The method comprises: capturing an air sample from the atmospheric environment; separating candidate particles of interest from the particles of non-interest; generating an image of the candidate particles; identifying a contaminant from among the candidate particles by comparing the generated image with a plurality of stored reference images, each of which reflects a contaminant; and notifying a remote third party in response to detecting a contaminant from among the candidate particles.

This prior art disclosure is designed for detecting airborne contamination caused by weapons of mass destruction, for example chemical and biological weapons.

WO 03/096375 A1 discloses a method of identifying individual aerosol particles in real time. A bipolar single particle mass spectrometer is used to produce bipolar aerosol mass spectral data from aerosol particles from the open atmosphere, for example. This is in view of the potential threat of biological and chemical warfare.

WO 2008/049038 A3 relates to an aerosol time-of-flight mass spectrometer (ATOFMS) for measuring the precise size and chemical composition of individual aerosol particles in real time. An aircraft ATOFMS is designed to provide aircraft-based measurements, meaning that it is installed inside an aircraft, which may be unmanned, to perform atmospheric chemical studies. The ATOFMS itself is typically the size of a small car so that it can fit inside a platform such as an aircraft, van, truck, helicopter or unmanned aerial vehicle.

The present invention seeks to provide an improved apparatus and method for identifying possible contaminants in air and in particular in the cabin and/or flight deck of an aircraft.

According to the present invention, there is provided an apparatus for monitoring air for target air contaminants comprising: means for sensing ultrafine particles in air; a database; and a processor for receiving information output from the sensing means; wherein the processor is adapted to monitor the information output from the sensing means and to use the information output from the sensing means to determine whether an instance of air contamination has occurred and, upon the processor determining that contamination has occurred, to compare the information output from the sensing means with data in the database to identify target air contaminants.

Thus, the processor is adapted to compare the information output from the sensing means with data in the database when the processor has detected that an instance of air contamination has occurred. In this respect, the processor detects that an instance of air contamination has occurred from the information received from the sensing means. In one example, a voltage response system is used: the processor monitors the voltage output from the sensing means.

When an incident of oil leakage occurs in an aircraft engine environment, ultrafine particles are often produced and can be transported into the aircraft cabin. The present inventors have discovered that there is a correlation between the ultrafine particles detected by the sensing means and the presence of volatile organic or semi-volatile organic compounds which are simultaneously released or subsequently generated. By suitable experiments involving the vaporisation of engine oils, the inventors have established a pattern between the information from the sensing means and the likely SVOCs and VOCs resulting from the incident. Thus, in the present invention, the ultrafine particles detected by the sensing means can effectively act as surrogates for the VOCs and SVOCs of concern. Also, the information output from the sensing means may be used by the processor to determine the likely concentration of the target air contaminants.

Preferably, the apparatus further comprises means for recording operating data such as air temperature and/or pressure whilst the apparatus is in use.

The apparatus may further comprise means for detecting when the apparatus is airborne, such as an altimeter, an accelerometer or a pressure transducer. This detecting means is adapted to switch the apparatus on once the aircraft is airborne. Alternatively, the apparatus may be manually activated, for example when the aircraft has commenced its flight.

The apparatus is preferably a standalone unit. It is preferably sufficiently portable to be carried by one person. It is preferably designed as a standalone discrete unit within an aircraft and configured so that people within the cabin are not aware of its purpose or its presence. The cabin is preferably that of an aircraft for transporting passengers and/or goods.

In one example, the apparatus of the present invention is adapted to be installed in an overhead locker of an aircraft cabin. In another example, the apparatus is adapted to be built in behind the internal facade of an aircraft cabin. In a further example, the apparatus is adapted to be located beneath a seat in an aircraft cabin.

Thus, the size of the apparatus is limited by the volume of its desired location. Preferably, the apparatus is adapted to fit within a space having a volume of 50 cubic litres. More preferably, the apparatus is adapted to fit within a space having a volume of 40 cubic litres. Most preferably, the apparatus is adapted to fit within a space having a volume of 30 cubic litres.

The apparatus is not a mass spectrometer and does not comprise a mass spectrometer: it is noted that these are too large for use in the present invention.

The present invention relates primarily to identifying leakage of oil or hydraulic fluid in an engine environment. The high temperatures and pressures there result in vaporisation of the leaked oil or fluid. There is increasing concern that the oil or fluid and their thermal breakdown products are being released into the aircraft cabin which is detrimental to the health of those onboard.

The thermal decomposition products of oil depend at least in part on the type of oil used. The engines of aircraft have many parts where oil is used, although each engine is generally provided with oil from a single reservoir. To understand the source of any oil leakage, the present invention envisages the potential for putting tracer compounds in oil (or other fluids) such that, upon its pyrolysis or vaporisation, the decomposition products of the tracer compound can be detected by the apparatus of the present invention, which can be used to help identify the source of the leaked oil from a specific engine. The apparatus of the present invention is therefore potentially suitable for identifying tracer compounds added to oil or hydraulic fluid, for example. The apparatus is also suitable for identifying the source of any oil leakage when different brands of oils are used in different engine parts, since the inventors have found that different brands of engine oil produce different voltage responses from the sensing means when the oils are vaporised.

Ultrafine particles are nano scale. They are a major concern for respiratory health since they are readily inhaled and are able to travel deep within a lung such that they are not easily removable from a body.

Ultrafine particles may be released by many different sources and are often present in air. However, when an instance of oil leakage occurs during an aircraft flight, the number of ultrafine particles in the cabin increases rapidly. Monitoring the concentration of the ultrafine particles can therefore be used to determine when an incident of oil leakage has occurred.

Preferably, the sensing means contains a variable voltage or digital output. This shows the detection of ultrafine particles as an increase in sensor output. Therefore, when an incident occurs and there is a larger concentration of ultrafine particles, there is also an increase in output from the sensor.

Preferably, the sensing means in the apparatus is adapted to continuously monitor the air once the apparatus has been activated. Thus, in contrast to the prior art, it does not capture an air sample.

Moreover, there is no system in the present invention for separating out and/or concentrating the ultrafine particles or the target compounds found in the air. Further, no microscope or other imaging device is used to visually detect the target compounds.

The sensing means may be provided with at least one particle-size filter. This may detect particles in a pre-determined range of particle sizes. If more than one particle-size filter is used, each filter is preferably adapted to detect particles having sizes which fall in a different range of sizes to the other filters. In a preferred embodiment, the sensing means comprises a plurality of sensors each provided with a particle-size filter; preferably each filter is adapted to detect particles having sizes which fall in a different range of sizes to the other filters.

In a preferred embodiment, the sensor is a Pegasor™ Particle Sensor available from Pegasor Oy (Ltd) in Finland.

An advantage of the present apparatus is that there are preferably no sampling tubes therein, such as the adsorbent tubes used in U.S. Pat. No. 7,824,479. This is because the processor identifies or tries to identify, via the data stored in the database, the likely organic compounds produced by the leakage incident from the information output from the sensing means showing that an incident has occurred. The resulting conclusions generated by the processor can either be viewed onboard the aircraft, stored for later review or transmitted as real-time information to ground control. The latter is a particularly useful way of monitoring the quality of air in an aircraft cabin. If those on the ground can find out whether an incident of oil leakage has occurred whilst an aircraft is in the air, it can use this information to try to repair the aircraft upon landing. Thus, real-time monitoring is possible and the aircraft repair can be efficiently executed with the aim of causing minimal delay, whilst ensuring the aircraft cabin environment is kept as safe as possible for those on board.

In one embodiment, at least one adsorbent tube may be present in the apparatus. This is for use simply as a checking tool. Preferably though, no adsorbent tube or other sampling means are present. Also, the apparatus of the present invention preferably has no means for storing air samples, such as Tedlar™ bags or other containers.

According to the present invention, there is also provided a method for monitoring air for target air contaminants comprising the following steps:
(a) monitoring ultrafine particles in air using a sensing means;
(b) outputting information from the sensing means to a processor;
(c) detecting contamination of the air using the information output from the sensing means;
(d) comparing the information output from the sensing means with data stored in a database regarding target air contaminants once air contamination has been detected;
(e) identifying any target air contaminants in the contaminated air.

The processor is preferably adapted to carry out the detection of step (c) and/or the comparison of step (d) and/or the identification of step (e).

The processor seeks to use the information output from the sensing means to determine whether an instance of air contamination has occurred and, upon the processor determining that contamination has occurred, to identify, by comparison with stored data, the likely presence of target volatile and/or semi-volatile organic compounds. The processor may also use the information output from the sensing means to determine the likely concentration of the target air contaminants.

Preferably, the method is continuous, so that it operates throughout a flight. The method may also be used to determine the source of the ultrafine particles and the air contaminants. The method preferably comprises measuring the temperature and/or pressure of the air.

The use of the above-mentioned apparatus and method on an aircraft for monitoring air inside the cabin and/or the flight deck of the aircraft is also disclosed.

An embodiment of the present invention will now be described, by way of example only, with reference to the accompanying diagrammatic drawing, in which:

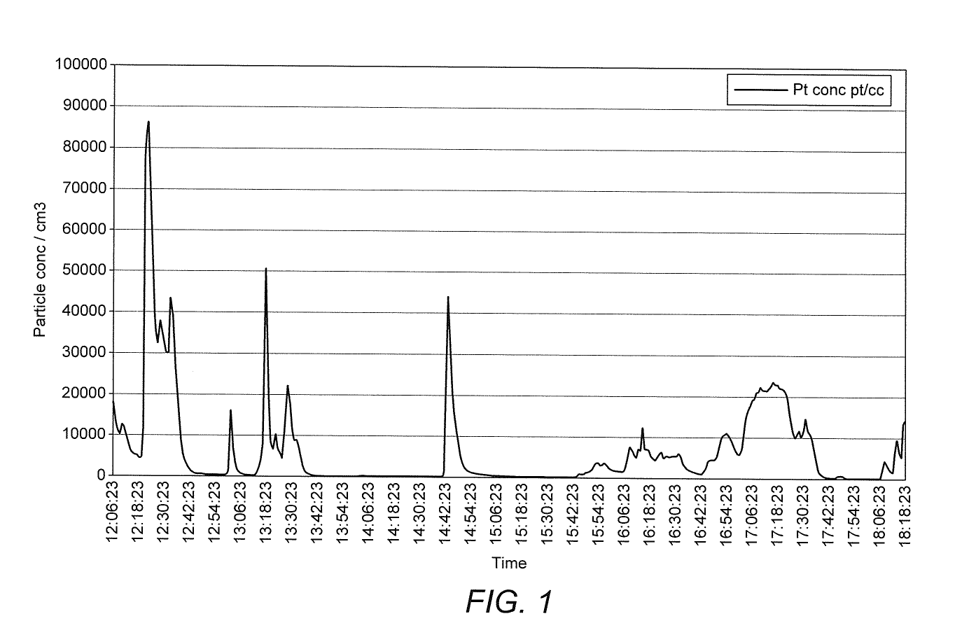

FIG. 1 is a graph of ultrafine particle concentration against time;

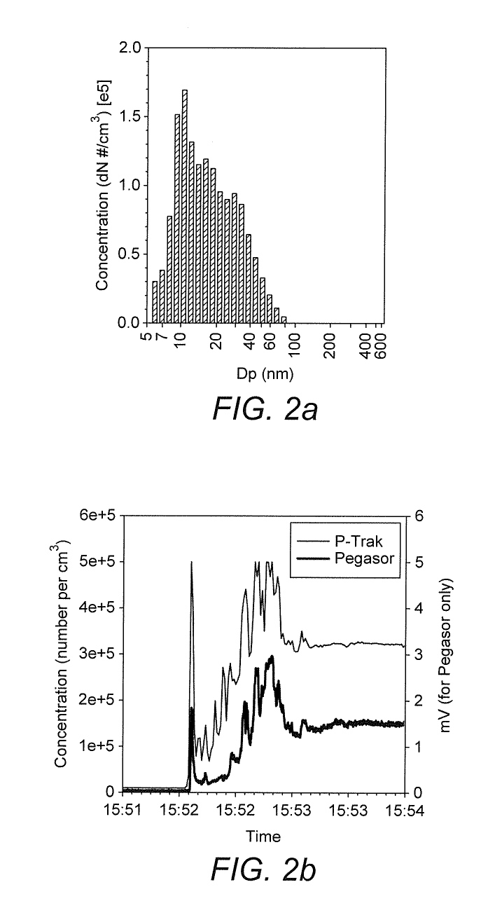

FIG. 2a is a graph showing particle size distribution for a first engine oil at 350° C.;

FIG. 2b is a graph of ultrafine particle concentration against time for the first engine oil at 350° C.;

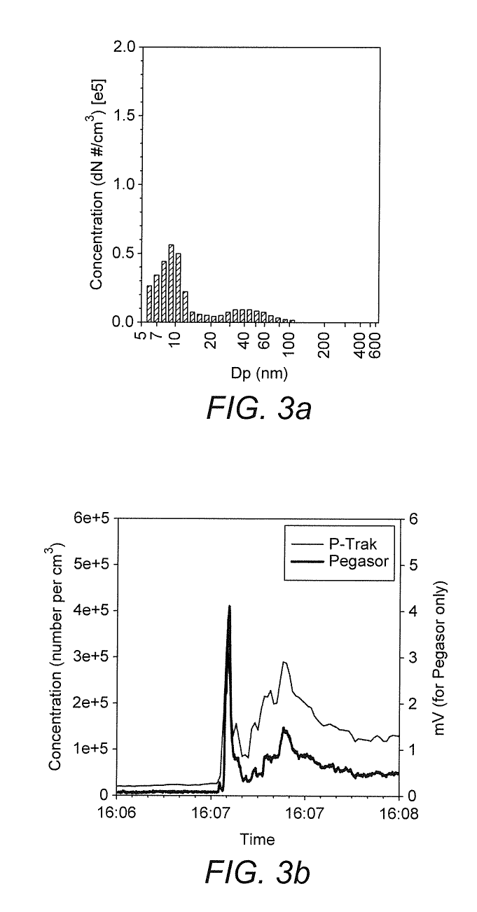

FIG. 3a is a graph showing particle size distribution for the first engine oil at 550° C.;

FIG. 3b is a graph of ultrafine particle concentration against time for the first engine oil at 550° C.;

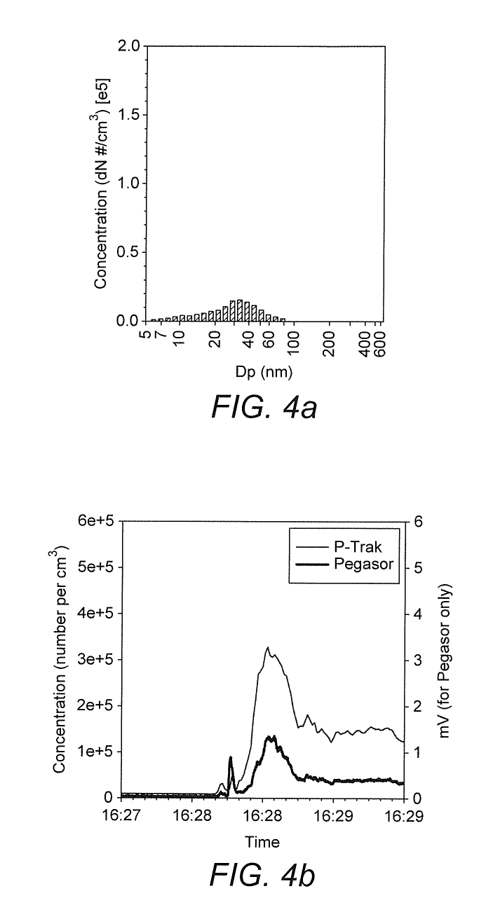

FIG. 4a is a graph showing particle size distribution for a second engine oil at 350° C.;

FIG. 4b is a graph of ultrafine particle concentration against time for the second engine oil at 350° C.;

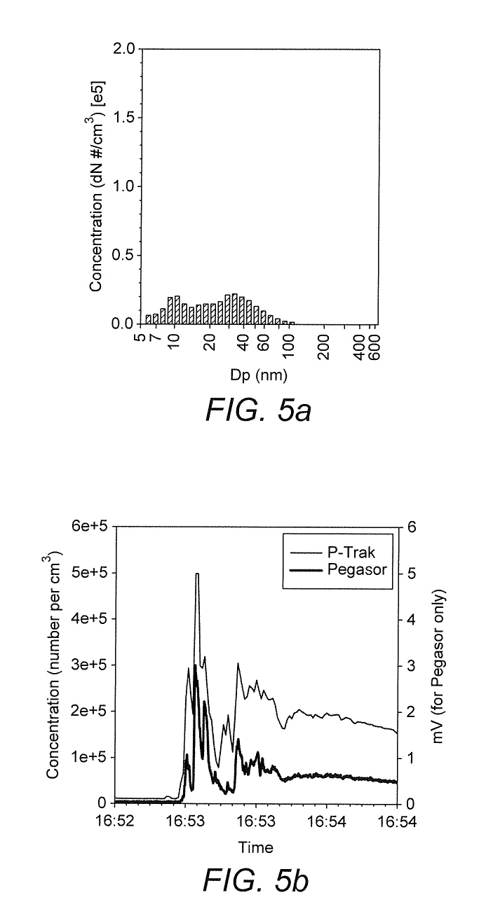

FIG. 5a is a graph showing particle size distribution for the second engine oil at 450° C.; and

FIG. 5b is a graph of ultrafine particle concentration against time for the second engine oil at 450° C.

The apparatus of the present invention is adapted to be located in an aircraft cabin. The apparatus is adapted to be continuously operating such that the sensing means continuously monitors the air and the information output from the sensing means is continually sent to the processor. Upon the information from the sensing means indicating that there has been a rapid increase in the number of ultrafine particles, the processor determines that contamination has occurred. The processor then compares the information from the sensing means with data stored in the database to try to identify the likely air contaminants and their concentrations.

The database and processor may be a single unit or the database may be separate to the processor. The processor may be a central processing unit.

The database contains experimentally-determined information correlating the ultrafine particle information output from the sensing means with the likely air contaminants and their concentrations. The processor is therefore able to make a comparison between the output of the sensing means and the stored data.

Referring to FIG. 1, it can be seen that during a four hour flight of an aircraft (time is shown every 12 minutes for ease of reference), the concentration of ultrafine particles varies from 0 to more than 80,000 particles per cm³. This data was collected on a real flight using a TSI P-Trak™ particle counting instrument available from TSI Instruments Ltd, UK. The peak on the graph at approximately 14.42.23 corresponds to a possible bleed-air contamination incident in-flight. The other peaks shown on the graph most likely correspond to other air contamination sources detected while the aircraft was on the ground.

According to the present invention, the apparatus preferably comprises a sensor with a variable voltage or digital output as the sensing means. The sensor output increases as the number of ultrafine particles in the air passing through the sensing means increases.

Ultrafine particle sensors detect particles having an aerodynamic diameter of less than 1 μm and preferably less than 0.1 μm. Generally, when these particles are detected by a sensor, there is an increase in its output and a corresponding electrical signal is sent to a processor. The output of the sensor is preferably also continuously recorded using a data-logging device.

Examples of possible alternative sensing means (or sensors) are set out below.

A suitable sensor is the Pegasor™ Particle Sensor available from Pegasor Oy (Ltd) in Finland. This operates by the electrostatic charging of particles passing through the sensor and measurement of the current resulting from the charged particles leaving the sensor. The sensor has a flow-through design that assists in keeping the sensor clean for extended periods of operation and lower maintenance requirements. The sensor can detect particles between a few nanometres in size up to approximately 2.5 μm, at concentrations between approximately 1 μg m⁻³ and 25 mg m⁻³.

A forward light scattering sensor may be used, whereby a laser beam is diffracted by a small angle by the smoke particles. An example is a Stratos-Micra 25 sensor which is available from AirSense Technology Ltd, UK. The Stratos-Micra is an air sampling smoke detector. It has a particle sensitivity range specified of 0.003 to 10 micrometres (although for airborne particles a range of 0.3 to 10 micrometres is more likely).

An alternative sensor is an ionisation smoke detector which operates as follows. When a small sample of air is ionised by means of a radioactive substance, the ions allow a small electrical current to flow between two electrodes placed in the sample. If smoke contaminates the air in the sample then the smoke inhibits the movement of the ions and the electrical current decreases. A suitable ionisation smoke detector (Series 65) is available from Apollo Fire Detectors Ltd, UK.

Another suitable sensor is a Cirrus ProLoctor which is based on a Cloud Chamber Detection principle. It is available from Safe Fire Detection Inc of the USA.

Another alternative is a TSI P-Trak™ Ultrafine Particle Counter from TSI Incorporated of the USA, which is based on a condensation nucleus counter. Here the particles are initially passed through a saturated vapour of propanol. This condenses on to them so that they grow to a size sufficiently large for them to scatter light and thus be measured by a focused laser light source and a photo detector.

The sensing means may be fitted with particle-size filters which detect particles in pre-determined ranges of particle sizes. In one example, three sensors are used (although more than three sensors or less than three sensors may also be used), each sensor being fitted with a filter which detects particles having sizes which fall in a different range of sizes to the other filters. The resulting output profiles of the three sensors provide useful information on the distribution of particle sizes when an incident of air contamination arises. This information may be compared with corresponding, experimentally-determined, information in the database to identify likely air contaminants. A statistical analysis of the data may also be useful in this respect.

Preferably, the apparatus of the present invention functions as a stand-alone unit and can be operated by a DC storage battery, for example. Thus, the sensor is preferably operational at low power or can be modified to be operational at low power. As an alternative to being a stand-alone unit, the apparatus can be connected to the electrical circuitry of an aircraft in which it is located.

When an aircraft is on the ground, the air both inside and outside the aircraft can be contaminated by particulate matter and chemical pollutants. This is caused, for example, by refuelling of the aircraft or by the engine exhausts of adjacent vehicles and aircraft. Thus, the sensor is preferably switched off when the aircraft is on the ground. In one embodiment, the sensor is switched on manually once the aircraft is sufficiently high in the air. However, in a preferred embodiment, means are provided for detecting when the apparatus is airborne. In the present embodiment, this means is a pressure transducer, although, by way of example, an accelerometer or an altimeter could also be used; please note that altimeters are generally based on pressure-transducers.

In an alternative embodiment, the sensor is activated on the ground and the processor monitors the output of the sensor and is able to detect, by tracing the ultrafine particles detected by the sensor, when the aircraft has left the ground. In this respect, the levels of ultrafine particles detected by the sensor decrease when the aircraft is airborne since the aircraft is away from the contaminated air near the ground and usually any re-circulated cabin air is passed through high-efficiency particle air (HEPA) filters. Typically the ultrafine particle concentration only increases for a minute or so when an incident of oil leakage, and therefore air contamination, occurs.

The table below sets out, by way of example only, concentration ranges of several analytes found by the inventors during short sampling periods taken during a few aircraft flights. One or more of these may be the target air contaminants of the present invention.

| Substance | ug/m³ |
|---|---|
| toluene | <3-120 |
| trichloroethylene | <0.1-0.8 |
| m xylene | <0.8-1.3 |
| limonene | 0.8-6 |
| undecane | <3-6 |
| hydraulic fluid | <2-3 |
| tricresyl phosphates | <0.03-0.1 |
| engine oil | <4-8 |

If one or more absorbent tubes are used for taking control or back-up samples during the flight, these may be set up as disclosed in U.S. Pat. No. 7,824,479 which is herein incorporated by reference in its entirety.

### EXAMPLES

The inventors took two commonly-used engine oils and placed 2 μl of each in a heated air stream; the oils vaporised in the heated air stream and the degradation products of each oil in the particle phase were measured using a Fast Mobility Particle Sizer FMPS (sourced from TSI; model number 3091) and also using a TSI P-Trak™ Ultrafine Particle Counter and a Pegasor™ Particle Sensor.

FIGS. 2a to 5b set out the results, as detailed below.

The Mobil Jet II engine oil (aircraft-type gas turbine lubricant) was sourced from Exxon Mobil Corporation, USA and the BP 2380 engine oil (BP Turbo Oil 2380) was sourced from BP plc, UK.

| | Temperature | |
|---|---|---|
| Engine oil used | of air stream ° C. | Results |
| Jet II | 350 | FMPS - FIG. 2a |
| Jet II | 350 | P-Trak/Pegasor - FIG. 2b |
| Jet II | 550 | FMPS - FIG. 3a |
| Jet II | 550 | P-Trak/Pegasor - FIG. 3b |
| BP2380 | 350 | FMPS - FIG. 4a |
| BP2380 | 350 | P-Trak/Pegasor - FIG. 4b |
| BP2380 | 450 | FMPS - FIG. 5a |
| BP2380 | 450 | P-Trak/Pegasor - FIG. 5b |

The Fast Mobility Particle Sizer measured the particle size distribution of the ultrafine particles produced by the vaporised oils. It can be seen that these distributions differ according to the brand of oil used and the temperature at which the oil decomposed.

The sensor responses of the TSI P-Trak™ Ultrafine Particle Counter and the Pegasor™ Particle Sensor showed good correlation and also different output profiles for the different oils and for the different temperatures.

The outputs of the Fast Mobility Particle Sizer, the TSI P-Trak™ Ultrafine Particle Counter and the Pegasor™ Particle Sensor show the concentrations of the ultrafine particles, either against particle size (the FMPS) or against time (the sensors). These outputs therefore provide information regarding the extent of oil leakage (ie the volume of oil vaporised) and thus the extent of potential exposure to the contaminants.

The output profiles vary according to the oil type in question and to the temperature of the oil vaporisation. The output profiles will also vary according to the pressure under which the oil is vaporised (the same pressure was used for all the experiments detailed above, this being room (atmospheric) pressure).

To put the invention into effect, a database is established of such output profiles from the sensors, using different oils at different temperatures and pressures.

Experimentally-determined information regarding the air contaminants produced by these vaporised oils is also obtained and entered into the database. For example, the oils are vaporised at specific temperatures and pressures; the vaporisation products are passed through an adsorbent tube or bag (for example a Tenax™ tube or a Tedlar™ bag); the airborne semi-volatile organic compounds (SVOCs) and volatile organic compound (VOCs) are captured by the adsorbent tube or bag; the SVOCs and VOCs are identified using analytical techniques such as gas chromatography/mass spectrometry.

The output profiles from the sensors are experimentally-correlated with the air contaminants produced by the thermal decomposition of oils. This information is stored in the database, ready for use in the present invention.

1. An apparatus for monitoring air for target air contaminants comprising:
means for sensing ultrafine particles in air;
a database; and
a processor for receiving information output from the sensing means;
wherein the processor is adapted to monitor the information output from the sensing means and to use the information output from the sensing means to determine whether an instance of air contamination has occurred and, upon the processor determining that contamination has occurred, to compare the information output from the sensing means with data in the database to identify any target air contaminants.

2. Apparatus as claimed in claim 1, wherein the sensing means has a variable voltage or digital ouput which is received by the processor.

3. Apparatus as claimed in claim 1, further comprising means for recording operating data whilst the apparatus is in use, the operating data preferably being air temperature and/or air pressure.

4. Apparatus as claimed in claim 1, further comprising means for detecting when the apparatus is airborne, this detecting means preferably being an altimeter, an accelerometer or a pressure transducer.

5. Apparatus as claimed in claim 1, wherein the sensing means is provided with at least one particle-size filter.

6. Apparatus as claimed in claim 1 which is adapted for continuous air monitoring.

7. Apparatus as claimed in claim 1 which is adapted for continuous in-flight monitoring of air within cabins and/or flight decks of aircraft.

8. Apparatus as claimed in claim 1, wherein the target air contaminants are volatile and/or semi-volatile organic compounds.

9. Apparatus as claimed in claim 8, wherein the target air contaminants are organophosphates.

10. Apparatus as claimed in claim 1 which has no means for storing samples of air.

11. A method for monitoring air for target air contaminants comprising the following steps:
(a) monitoring ultrafine particles in air using a sensing means;
(b) outputting information from the sensing means to a processor;
(c) detecting contamination of the air using the information output from the sensing means;
(d) comparing the information output from the sensing means with data stored in a database regarding target air contaminants once air contamination has been detected;
(e) identifying any target air contaminants in the contaminated air.

12. A method as claimed in claim 11, wherein the processor is adapted to carry out the detection of step (c) and/or the comparison of step (d) and/or the identification of step (e).

13. A method as claim in claim 11, wherein the sensing means has a variable voltage or digital output which is received by the processor.

14. A method as claimed in claim 11, wherein the monitoring in step (a) is continuous.

15. A method as claimed in claim 11, further comprising measuring the temperature and/or the pressure of the air.

16. A method as claimed in claim 11, wherein the sensing means is provided with at least one particle-size filter.

17. A method as claimed in claim 11, wherein the target air contaminants are volatile and/or semi-volatile organic compounds.

18. Use of the apparatus as claimed in claim 1 on an aircraft for monitoring air within the cabin and/or the flight deck of the aircraft.

19. Use of the method as claimed in claim 11 on an aircraft for monitoring air within the cabin and/or the flight deck of the aircraft.
